(19) United States
(12) Patent Application Publication
(10) Pub. No.: US 2014/0042976 A1
(43) Pub. Date: Feb. 13, 2014

(54) CHARGING METHOD FOR ADJUSTING CHARGING CURRENT

(71) Applicant: Compal Electronics, Inc., Taipei City (TW)

(72) Inventor: Chi-Ming LAN, Taipei City (TW)

(73) Assignee: Compal Electronics, Inc., Taipei City (TW)

(21) Appl. No.: 13/965,100

(22) Filed: Aug. 12, 2013

Related U.S. Application Data
(60) Provisional application No. 61/682,300, filed on Aug. 12, 2012.

(51) Int. Cl. H02J 7/00

(52) U.S. Cl. CPC H02J 7/0068
USPC 320/130

(57) ABSTRACT

Disclosed herein is a charging method for adjusting the charging current. The charging method includes the following steps: reading a present number of times of charging/discharging cycle and a rated number of times of charging/discharging cycle by a charging system; computing a charging/discharging ratio between the present number of times of charging/discharging cycle and the rated number of times of charging/discharging cycle by the charging system; generating a current drop ratio from a function of the charging/discharging ratio and a percent charging current by the charging system, wherein the current drop ratio is in a range of 0 to 1; and the charging system adjusting the charging current of a rechargeable battery based on the current drop ratio.

### RELATED APPLICATIONS

This application claims priority to U.S. Patent Application No. 61/682,300, filed Aug. 12, 2012, the entirety of which is herein incorporated by reference.

### BACKGROUND

1. Technical Field

The present disclosure relates to a charging method and a charging system, and more particularly, a method for adjusting a charging current and a charging system.

2. Description of Related Art

With the development of the human society, products on the market are designed to be more convenient and practical in use, and cost effective. In the mean time, the development of electronic products need even more efforts so as to keep up with the advance of the human society.

Certain electronic products, such as laptops, are powered by a charger operation of the battery and/or the power outlet. To the charger operation, the end users always desire a fast-rechargeable battery with a great number of charging cycles. Generally, the rechargeable battery ages with the usages times and time increase; said aging will cause the decrease of the battery capacity, and degrade the storage capability thereof. However, when charging a battery, conventional chargers will output a fixed output current as the charging current to charge the rechargeable battery. In other words, the current output by the charger will not change depending on the battery capacity of the rechargeable battery, but a current with fixed amperage is output. This charging mechanism would accelerate the degradation of the battery capacity during the repeated charging/discharging cycle of the rechargeable battery, thereby shortening the service life of the rechargeable battery.

In view of the foregoing, there exist problems and disadvantages in the existing charging methods that await further improvement. However, those skilled in the art sought vainly for a solution. In order to solve or circumvent above problems and disadvantages, there is an urgent need in the related field to adjust charging current more efficiently thereby prolonging the service life of the rechargeable battery.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides a charging method for adjusting a charging current of an electronic device so as to overcome the problems which has faced the prior art.

According to one embodiment of the present disclosure, a charging method comprises the following steps: using a charging system to read a present number of times of charging/discharging cycle and a rated number of times of charging/discharging cycle of a rechargeable battery, using the charging system to compute a charging/discharging ratio between the present number of times of charging/discharging cycle and the rated number of times of charging/discharging cycle; generating a current drop ratio from a function of the charging/discharging ratio and a percent charging current by the charging system, wherein the current drop ratio is in a range of 0 to 1; and adjusting a charging current of the rechargeable battery by the charging system based on the current drop ratio.

In the above-mentioned charging method, the function is: f(x)=a x²−b x+c, wherein f(x) is the current drop ratio, x is the charging/discharging ratio, and a>0, b>0, c>0.

The above-mentioned charging method may comprise: after the charging system obtaining the charging/discharging ratio, using the charging system to determine a relationship between the charging/discharging ratio and a setting value; and when the charging/discharging ratio is greater than the setting value, the function is: f(x) x²−b x+c, wherein f(x) is the current drop ratio, x is the charging/discharging ratio, and a>0, b>0, 1≧c>0.

Further, the above-mentioned charging method may also comprise: when the charging/discharging ratio is less than the setting value, the function is: f(x)=d x²−e x+f, wherein f(x) is the current drop ratio, x is the charging/discharging ratio, and a>d>0, e>0, 1≧f>0.

Additionally, in the above-mentioned charging method(s), the charging system may comprise a processing unit, and the processing unit is configured to compute the current drop ratio and adjust the charging current based on the current drop ratio.

According to another embodiment of the present disclosure, a method for adjusting a charging current comprises the following steps: using a charging system to read a present number of times of charging/discharging cycle and a rated number of times of charging/discharging cycle of a rechargeable battery; using the charging system to compute a charging/discharging ratio between the present number of times of charging/discharging cycle and the rated number of times of charging/discharging cycle; using the charging system to determine a relationship between the charging/discharging ratio and a setting value; when the charging/discharging ratio is greater than the setting value, generating a first current drop ratio from a first function of the charging/discharging ratio and a percent charging current by the charging system, and using the charging system to adjust a charging current of the rechargeable battery based on the first current drop ratio; when the charging/discharging ratio is less than the setting value, generating a second current drop ratio from a second function of the charging/discharging ratio and a percent charging current by the charging system, and using the charging system to adjust a charging current of the rechargeable battery based on the second current drop ratio.

The first function is: f(x)=a x²−b x+c wherein f(x) is the first current drop ratio, x is the charging/discharging ratio, and a>0, b>0, 1≧c>0.

The second function is: f(x)=d x²−ex+f, wherein f(x) is the second current drop ratio, x is the charging/discharging ratio, and a>d>0, e>0, 1≧f>0.

The charging system comprises a processing unit, and the processing unit is configured to compute the first current drop ratio and adjust the charging current based on the first current drop ratio.

The charging system comprises a processing unit, and the processing unit is configured to compute the second current drop ratio and adjust the charging current based on the second current drop ratio.

In view of the foregoing, the technical solutions of the present disclosure result In significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

1. Using a quadratic function to compute a current drop ratio corresponding to the charging/discharging ratio, and adjust the charging current of the rechargeable battery based on the current drop ratio, so as to avoid the acceleration of the degradation of the charging capacity; and

2. Effectively prolonging the service life of the rechargeable battery.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram illustrating a charging system according to one embodiment of the present disclosure;

FIG. 2 is a diagram illustrating a percent charging current according to one embodiment of the present disclosure; and

FIG. 3 is a flow diagram illustrating a charging method according to one embodiment of the present disclosure.

### DETAILED DESCRIPTION

In the following detailed description, for purposes of explanation, numerous specific details are set forth in order to attain a thorough understanding of the disclosed embodiments. In accordance with common practice, the various described features/elements are not drawn to scale but instead are drawn to best illustrate specific features/elements relevant to the present invention. Also, like reference numerals and designations in the various drawings are used to indicate like elements/parts. Moreover, well-known structures and devices are schematically shown in order to simplify the drawing and to avoid unnecessary limitation to the claimed invention.

In the detailed description and claims, the description in relation to the term “coupled to/with” generally refers to the case where one component is indirectly connected to another component via any other component, or one component is directly connected to another component without using any other component.

As used herein and in the claims, the singular forms “a” and “an” and the term “the” include the plural reference unless the context clearly indicates otherwise.

Also, as used in the description herein and throughout the claims that follow, the term “about” modifying any quantity refers to variation in the numerical quantity that would not affect the nature of the quantity. Unless specified otherwise, in the present embodiments, the term “about” means within 20% of the reported numerical value, preferably within 10% of the reported numerical value, and more preferably within 5% of the reported numerical value.

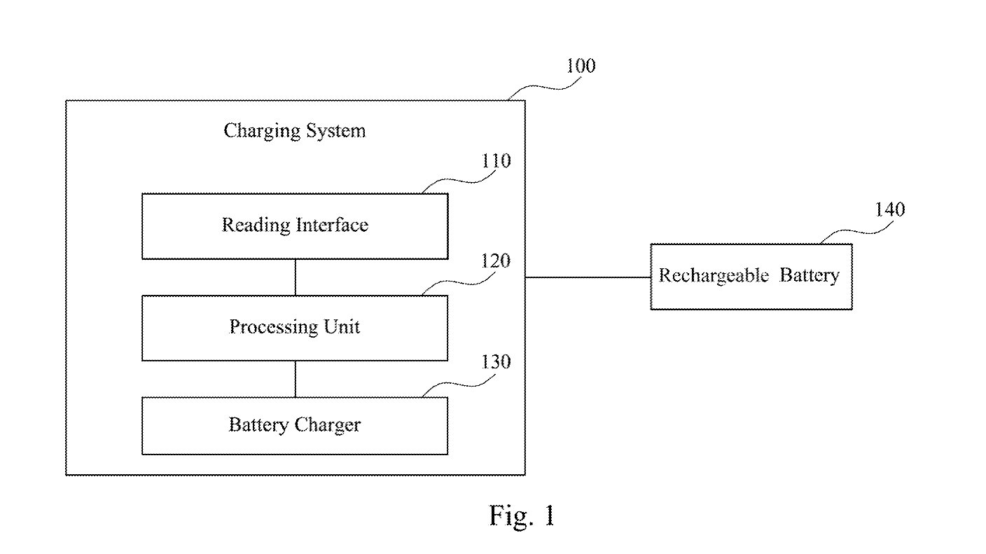

The technical aspect of the present disclosure is related to a charging system, which can be applied in various electronic devices, or more generally in related technical fields. It should be noted that the charging system according to the present disclosure may effectively prolong the service life of the rechargeable battery. Detailed embodiments of the present charging system is described below in connection with FIG. 1.

FIG. 1 is a block diagram illustrating the charging system 100 for used in an electronic device, according to one embodiment of the present disclosure. As illustrated in FIG. 1, the charging system 100 for adjusting the charging current includes a reading interface 110, a processing unit 120 and a battery charger 130.

In the present example, the reading interface 110 serves as the medium for communicating signals between the charging system 100 and the rechargeable battery 140; the reading interface 110 can adopt any suitable communication protocols; for example, the reading interface 110 can be a system management bus or the like. The processing unit 120 is configured to process the battery data and determine the suitable charging current and voltage; the battery charger 130 is responsible for actually outputting the charging current and voltage to the rechargeable battery 140. The rechargeable battery 140 includes one or more smart battery unit in conjunction with a printed circuit board +assembly (PCBA) or apparatus.

In structure, the rechargeable battery 140 is electrically coupled to the reading interface 110, the reading interface 110 is electrically coupled to the processing unit 120, the processing unit 120 is electrically coupled to the battery charger 130, and the battery charger 130 is electrically coupled to the rechargeable battery 140.

In operation, the reading interface 110 is configured to read a present number of times of charging/discharging cycle and a rated number of times of charging/discharging cycle of the rechargeable batter 140. The processing unit 120 is configured to compute a charging/discharging ratio (s/k) between the present number of times of charging/discharging cycle (s) and the rated number of times of charging/discharging cycle (k), and then use a function of the charging/discharging ratio and a percent charging current to generate a current drop ratio, wherein the current drop ratio is in a range of 1 and 0. The processing unit 120 is configured to compute the current drop ratio and adjust charging current based on the current drop ratio, such that the battery charger 130 adjusts the current used to charge the rechargeable battery 140 accordingly. For example, the processing unit 120 may be an embedded controller of the system of the electronic device.

During the implementation process, the relationship between the charging/discharging ratio (s/k) and the percent charging current is substantially in the form of a quadratic function; in the charging system 100, said function is: f(x)=a x² b−x+c, wherein f(x) is the current drop ratio, x is the charging/discharging ratio, and a>0, b>0, c>0. In practice, the specific value of a, b, c reflects the actual current drop curve, if the dropping extent is more drastic, the value of a is greater; c represents the initial current drop ratio, and hence 1≧c.

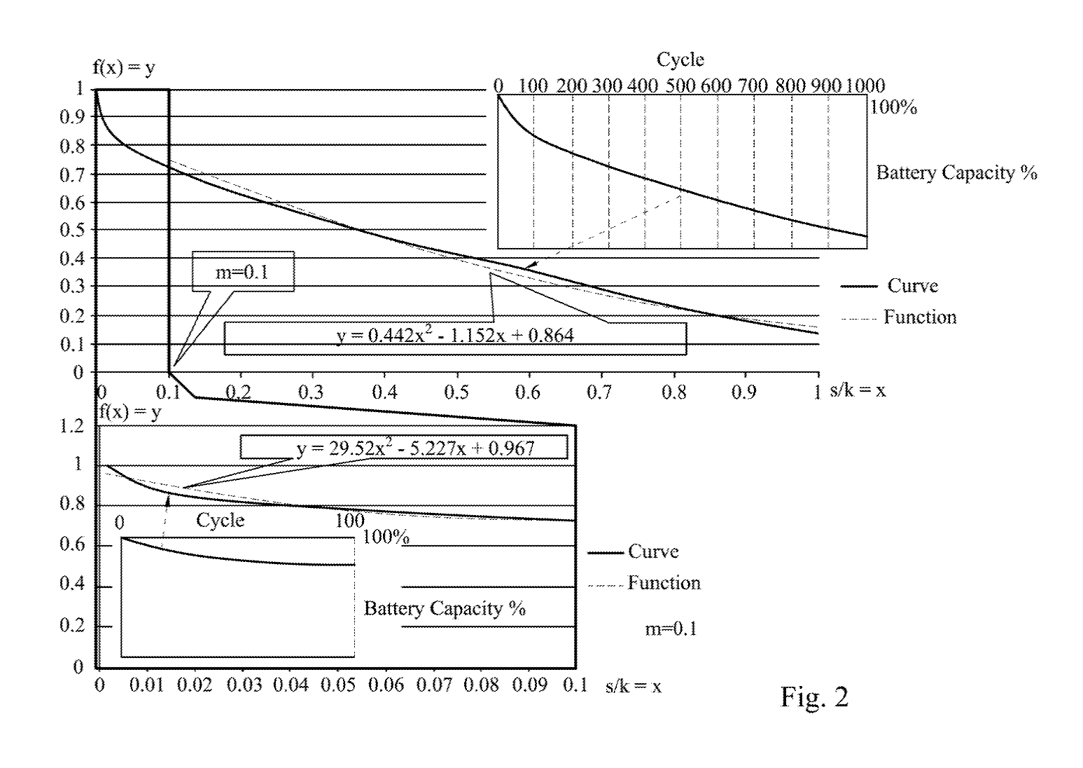

Please refer to both FIG. 1 and FIG. 2, the charging system 100 may convert the relationship between the battery capacity and cycle into the drop curve of the percent charging current, and then use a plurality of quadratic functions that respectively corresponding to different segments of the current drop curve, so as to fit the shape to the current drop line more closely. In one embodiment, it is feasible to use two quadratic function; that is, when the charging/discharging ratio (s/k) is between 0 to the setting value (m), a first function: f(x)=a x²−b x+c is used; for example, as illustrated in FIG. 2, if 0<x<m=0.1, then a=29.52, b=5.227, c=0.967, so as to fit the more drastic drop line in the former segment; whereas when the charging/discharging ratio (s/k) is between the setting value (m) and 1, a second function: f(x)=d x²−e x+f is adopted; for example, as illustrated in FIG. 2, if 0<x<m=0.1, then d=0.442, e=1.152, f=0.864, so as to fit the more moderate drop curve in the later segment.

In this way, in the charging system 100, after obtaining the charging/discharging ratio (s/k), the processing unit 120 may determine a relationship between the charging/discharging ratio (s/k) and the setting value (m); when the charging/discharging ratio (s/k) is greater than setting value (m), the processing unit 120 uses the first function: f (x)=a x2−b x+c to generate a first current drop ratio, wherein f(x) is the first current drop ratio, x is the charging/discharging ratio, and a>0, b>0, 1≧c>0. Further, when the charging/discharging ratio (s/k) is less than the setting value (m), the processing unit 120 uses the second function to generate a second current drop ratio: f (x)=d x²−e x+f, wherein f(x) is the second current drop ratio, x is the charging/discharging ratio, and a>d>0, e>0, 1≧f>0. Next, the processing unit 120 may determine a new charging current (C_{new}) based on the current drop ratio f(x), and adjust the charging current of the rechargeable battery 140 accordingly, wherein the new charging current (C_{new}) satisfies the following equation: C_{new}=Cf (x), wherein C is the rated charging current, f(x) is the current drop ratio. In the present embodiment, a charging voltage determined by the processing unit 120 may be a fixed voltage set depending on the specification of the rechargeable battery 140.

Moreover, the processing unit 120 may simulate different charging/discharging ratios (s/k=x) and data of current drop ratio f(x) corresponding thereto based on the above-mentioned function relationship, and establish a lookup table (such as, Table 1, below) therefrom,

TABLE 1

| x | f(x) |
|---|---|
| V₁ | U₁ |
| V₂ | U₂ |
| • | • |
| • | • |
| • | • |
| Vₙ₋₁ | Uₙ₋₁ |
| Vₙ | Uₙ |

wherein U₁ ≠ U₂ ≠ • • • ≠ Uₙ₋₁ ≠ Uₙ, n > 0
V₁ ≠ V₂ ≠ • • • ≠ Vₙ₋₁ ≠ Vₙ, n > 0.

For example, take the data corresponding to FIG. 2 as an example, x=0.01, then f(x)=0.8961; x=0.02 then f(x)=0.8486; . . . ; x=0.95, then f(x)=0.1543; x=1, then f(x)=0.1335. Moreover, a storage unit internal or external to the charging system 100 may store the lookup table for subsequent lookup so as to adjust the charging current.

The processing unit 120 as described above may be embodied as a software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. It should be noted that none of the above-mentioned examples is inherently superior to the other and is not intended to limit the present invention. Those having ordinary skill in the art may flexible selecting the way in which the any implementation to be utilized is a choice dependent upon the context in which the processing unit 120 is implemented depending on actual needs.

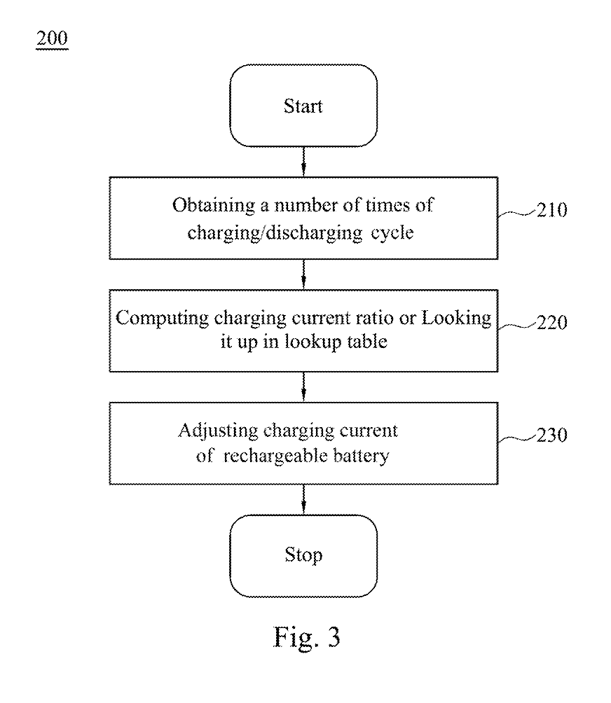

FIG. 3 is a flow chart illustrating a charging method 200 according to one embodiment of the present disclosure. As illustrated, the charging method 200 comprises steps 210 to 230, It should be appreciated that the steps are not recited in the sequence in which the steps are performed. That is, unless the sequence of the steps is expressly indicated, the sequence of the steps is interchangeable, and all or part of the steps may be simultaneously, partially simultaneously, or sequentially performed. Also, the hardware devices for implementing these steps have been specifically disclosed in the above embodiments, and hence, detailed description thereof is omitted herein for the sake of brevity.

In step 210, the charging system reads a present number of times of charging/discharging cycle and a rated number of times of charging/discharging cycle of the rechargeable battery. In step 220, the charging system may compute a charging/discharging ratio of the present number of times of charging/discharging cycle and the rated number of times of charging/discharging cycle, and use a function of the charging/discharging ratio and a percent charging current to obtain a current drop ratio, wherein the current drop ratio is in a range of 1 to 0. In step 230, the charging system adjusts the charging current of the rechargeable battery based on the current drop ratio.

In the charging method 200, the above-mentioned function is: f(x)=a x²−b x+c, wherein f(x) is the current drop ratio, x is the charging/discharging ratio, and a>0, b>0, c>0.

Please refer to both FIG. 2 and FIG. 3, the charging method 200 convert the relationship between the battery capacity and cycle into the drop curve of the percent charging current, and then use a plurality of quadratic functions that respectively corresponding to different segments of the current drop curve, so as to fit the shape to the current drop line more closely, In one embodiment, the charging method 200 may comprise, after the charging system obtaining the charging/discharging ratio (s/k), using the charging system to determine a relationship between the charging/discharging ratio (s/k) and the setting value (m); when the charging/discharging ratio (s/k) is greater than the setting value (m), the charging system using a first function: f (x)=a x²−b x+c to obtain a first current drop ratio, wherein f(x) is the first current drop ratio, x is the charging/discharging ratio, and a>0, b>0, for example, as illustrated in FIG. 2, if 0<x<m=0.1 then a=29.52, b=5.227, c=0.967, so as to fit the more drastic drop line in the former segment.

Moreover, the charging method 200 may also include: when the charging system determines that the charging/discharging ratio (s/k) is less than the setting value (m), the charging system using a second function: f(x)=d x²e x+f to obtain a second current drop ratio, wherein f(x) is the current drop ratio, x is the charging/discharging ratio, and a>d>0, e>0, 1≧f>0; for example, as illustrated in FIG. 2, if 0<x<m=0.1, then d=0.442, a=1.152, f=0.864, so as to fit the more moderate drop curve in the later segment.

Further, the charging method 200 may also include: in one embodiment, the processing unit 120 (illustrated in FIG. 1) being configured to compute a first current drop ratio and adjust the charging current based on the first current drop ratio; alternatively or additionally, the processing unit 120 being configured to compute a second current drop ratio and adjust charging current based on the second current drop ratio.

Additionally, the charging method 200 may include: simulating different charging/discharging ratios and data of current drop ratio f(x) corresponding thereto based on the above-mentioned function relationship, and establish a lookup table (such as, Table 1, above) therefrom, and thereby, in step 220, it is feasible to find out the drop rate of the current by looking it up in the table.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A charging method for adjusting a charging current, comprising:
using a charging system to read a present number of times of charging/discharging cycle and a rated number of times of charging/discharging cycle of a rechargeable battery;
using the charging system to compute a charging/discharging ratio between the present number of times of charging/discharging cycle and the rated number of times of charging/discharging cycle;
generating a current drop ratio from a function of the charging/discharging ratio and a percent charging current by the charging system, wherein the current drop ratio is in a range of 0 to 1; and
adjusting a charging current of the rechargeable battery by the charging system based on the current drop ratio.

2. The charging method according to claim 1, wherein the function
f(x)=ax²−bx+c
wherein f(x) is the current drop ratio, x is the charging/discharging ratio, and a>0, b>0, c>0.

3. The charging method according to claim 1, further comprising:
after obtaining the charging/discharging ratio, determining a relationship between the charging/discharging ratio and a setting value; and
when the charging/discharging ratio is greater than the setting value, the function is:
f(x)=ax²−bx+c
wherein f(x) is the current drop ratio, x is the charging/discharging ratio, and a>0, b>0, 1≧f>0.

4. The charging method according to claim 3, further comprising:
when the charging/discharging ratio is less than the setting value, the function is:
f(x)=dx²−ex+f
wherein f(x) is the current drop ratio, x is the charging/discharging ratio, and a>d>0, e>0, 1≧f>0.

5. The charging method according to claim 1, wherein the charging system comprises a processing unit and the processing unit is configured to compute the current drop ratio and adjust the charging current based on the current drop ratio.

6. A method for adjusting a charging current, comprising:
using a charging system to read a present number of times of charging/discharging cycle and a rated number of times of charging/discharging cycle of a rechargeable battery;
using the charging system to compute a charging/discharging ratio between the present number of times of charging/discharging cycle and the rated number of times of charging/discharging cycle;
using the charging system to determine a relationship between the charging/discharging ratio and a setting value;
when the charging/discharging ratio is greater than the setting value, generating a first current drop ratio from a first function of the charging/discharging ratio and a percent charging current by the charging system, and using the charging system to adjust a charging current of the rechargeable battery based on the first current drop ratio;
when the charging/discharging ratio is less than the setting value, generating a second current drop ratio from a second function of the charging/discharging ratio and a percent charging current by the charging system, and using the charging system to adjust a charging current of the rechargeable battery based on the second current drop ratio.

7. The charging method according to claim 6, wherein the first function is
f(x)=ax²−bx+c
wherein f(x) is the first current drop ratio, x is the charging/discharging ratio, and a>0, b>0, 1≧c>0.

8. The charging method according to claim T, wherein the second function is
f(x)=dx²−ex+f
wherein f(x) is the second current drop ratio, x is the charging/discharging ratio, and a>d>0, e>0, 1≧f>0.

9. The charging method according to claim 6, wherein the charging system comprises a processing unit, and the processing unit is configured to compute the first current drop ratio and adjust the charging current based on the first current drop ratio.

10. The charging method according to claim 6, wherein the charging system comprises a processing unit, and the processing unit is configured to compute the second current drop ratio and adjust the charging current based on the second current drop ratio.
